(19) United States
(12) Patent Application Publication
(10) Pub. No.: US 2014/0279124 A1
(43) Pub. Date: Sep. 18, 2014

(54) SYSTEM AND METHOD FOR PROVIDING ACCESS TO USER GENERATED CONTENT

(71) Applicant: Daniel M. Rotar, Youngstown, OH (US)

(72) Inventor: Daniel M. Rotar, Youngstown, OH (US)

(21) Appl. No.: 13/833,924

(22) Filed: Mar. 15, 2013

(51) Int. Cl. G06Q 30/06

(52) U.S. Cl. CPC G06Q 30/0601
USPC 705/26.1

(57) ABSTRACT

The present invention provides systems and methods for providing users with access to content generated by other users, while limiting access based on which constituent virtual items the user has purchased. In an exemplary embodiment, a system according to the present invention provides mechanisms for determining constituent virtual items contained within content stored in a central repository, determining virtual items which have been purchased by a user, and enabling a user to download content which had been previously uploaded to a central repository only if the user has purchased all of the one or more purchasable virtual items contained within the content.

This application claims benefit of priority from U.S. Provisional Patent Application No. 61/652,157, filed May 26, 2012.

### TECHNICAL FIELD OF INVENTION

The present invention relates to systems and methods for providing users with access to content generated by other users.

### BACKGROUND OF THE INVENTION

Many games and other types of applications implemented on computers, including mobile devices, provide a virtual environment which can be populated by a user using virtual items, which are provided by the application, to produce user generated content. Such virtual items may, for example, include game characters, objects, sounds, and other items. Some of the virtual items may be made available to the user upon downloading or purchasing the application. Other items may be made available to the user once the user reaches a predetermined level or rank within the application. Other items may be made available to the user once the user purchases the item through a purchase mechanism provided by the application.

### SUMMARY OF THE INVENTION

The present invention pertains to methods and systems for providing users with access to content generated by other users. Many applications and computer systems allow users to create original content (user generated content) and upload this content to a central repository. This allows for other users to view this content, and, possibly, create their own derivative works. The present invention provides systems and methods for providing users with access to content generated by other users while limiting user access to instances of user generated content based on which constituent virtual items the user has purchased. The system may be configured to enable a user to obtain certain virtual items by purchasing the items with actual currency and to enable the user to obtain other virtual items by purchasing the items with a virtual currency, which for example, may be obtained by the user as a reward for achieving goals within the application. The invention can be implemented in numerous ways, including as a method, system, device, or apparatus (including computer readable medium or graphical user interface). Several embodiments of the invention are discussed below.

In an exemplary embodiment, a second user is provided access to the content generated by a first user if and only if the second user has purchased all of the purchasable virtual items contained within the content generated by the first user.

An exemplary embodiment of the present invention includes a system in which an individual instance of user generated content is comprised of a number of virtual items. For example, a song generated by a first user may be comprised of instances of plano sounds, drum sounds, and guitar sounds. An application according to an embodiment of the present invention may be configured such that access to the plano sounds, drum sounds, and guitar sounds would have been purchased by a first user before he or she would be permitted to create content containing them. The application enables the first user to upload his or her song to a central repository of user generated songs, and metadata pertaining to the songs (title, author, etc.) would be publicly listed by the central repository. However, the system would prevent a second user from viewing the first user's content unless the system determines that the second user has purchased all the constituent items of which the first user's song is composed, such as the plano, drum, and guitar sounds.

Another exemplary embodiment of the present invention includes a system that allows a user to construct a virtual, physically simulated scene using virtual items such as walls, ropes, joints, wheels, etc. Some of the virtual items may be freely available to the user upon purchase of the application. Other virtual items may only be made available to the user if the user has purchased the item. In an exemplary embodiment, the system provides a mechanism which enables the user to upload scenes to a central repository, and lists metadata pertaining to it among metadata for other instances of user generated content. The system provides other users with access to this list of metadata, but only permits a particular user to view an individual instance of content if that user has access to all of the constituent items the content is composed of. In an exemplary embodiment, if a user tries to access content without having purchased all the necessary items, the system gives the user an opportunity to purchase the items (which consequently would enable them to view the content).

As a computer-implemented method for providing a second user with access to content generated by a first user, an embodiment of the invention includes the steps of storing content created by a first user, the content comprising or having been created through the use of one or more purchasable virtual items; storing metadata associated with the content; providing a second user access to the metadata; and providing the second user access to the content if and only if the second user has purchased all of the one or more purchasable virtual items contained within the content. The method may further include the step of presenting the second user with the option to purchase all of the purchasable virtual items needed to access the content if the second user has not previously purchased all of the purchasable virtual items contained within the content.

One embodiment of the invention provides a computer readable medium including executable computer program code tangibly stored thereon for identifying virtual items which are contained within specific content, but which have not been purchased by the user attempting to view the content, and disallowing viewing of the content by the user until these items are purchased by the user.

As an application system, one embodiment of the invention includes a central repository, a first embodiment of an application stored on a first user's device, a second embodiment of an application stored on a second user's device, each embodiment capable of communicating with the central repository, the first application embodiment capable of facilitating the generation of content composed of or created through the use of one or more purchasable virtual items, converting the content into transmittable content data, and transmitting the content data to the central repository; the central repository capable of receiving, storing, and transmitting content data; the second application embodiment capable of requesting access to specific content data from the central repository, receiving this content data, converting the content data into human viewable content, and displaying the content; and at least one of the application embodiments and the central repository capable of identifying which virtual items are contained within or were used to create specific content, but which have not been purchased by the user attempting to view the content, and disallowing viewing of the content by the user until these items are purchased by the user. In an exemplary embodiment, the first and second applications are identical. Alternatively, the first and second applications are distinct from each other.

Further features, uses and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a block diagram of an electronic system according to an exemplary embodiment of the present invention;

FIG. 2 is a process flow diagram of a preferred method according to the present invention;

FIG. 3 is a flow diagram of an exemplary embodiment of a method, which incorporates client based purchase tracking, according to the present invention;

FIG. 4 is a process flow diagram of an exemplary embodiment of a method, which incorporates server based purchase tracking, according to the present invention;

FIG. 5 is a block diagram illustrating an architecture, which incorporates client based purchase tracking, according to an embodiment the present invention;

FIG. 6 is a block diagram illustrating an architecture, which incorporates server based purchase tracking, according to an embodiment of the present invention;

FIG. 7 illustrates an exemplary menu according to an embodiment of the present invention; and

FIG. 8 illustrates another exemplary menu according to an embodiment of the present invention.

### DETAILED DESCRIPTION OF INVENTION

The invention generally relates to systems and methods for providing users with access to content generated by other users and for limiting user access to instances of user generated content based on which constituent virtual items the user has purchased.

FIG. 1 is a block diagram of an electronic system 100 according to an exemplary embodiment of the present invention. The electronic system 100 includes an on-line central repository 102 and one or more client devices 104 for use by end users. The client devices 104 communicate with the on-line central repository 102 via a data network 106.

Client device 104 hosts a computer program 108, such as a client game application (CGA) or a media creation application. The computer program 108 is adapted and configured for facilitating the generation of content comprising one or more purchasable virtual items, tracking virtual items which were purchased, converting the content into transmittable content data, and transmitting the content data via the data network 106 to the repository 102. The computer program 108 is also adapted and configured for requesting access to specific identified content data from the repository 102, identifying purchasable virtual items included in or having been used to create the identified content in the repository 102 that have not been purchased by the user, prompting the user of the client device 104 to pay for unpurchased purchasable virtual items, disallowing viewing of the content by the user attempting to view the content until these items are purchased by the user, receiving the content data when all purchasable virtual items have been paid for, converting the content data into human viewable content, and displaying the content to an end user. Alternatively, one or more of the steps of identifying purchasable virtual items included in or having been used to create the identified content in the repository 102 that have not been purchased by the user, prompting the user of the client device 104 to pay for unpurchased purchasable virtual items, and disallowing viewing of the content by the user attempting to view the content until these items are purchased by the user may be performed by the repository 102 instead of the client device 104.

The repository 102 includes a front end server 108 adapted and configured for processing requests from the client device 104, for receiving content data from client devices 104, and transmitting content data to client devices 104. The repository 102 further includes a database 112 coupled to the front end server 110 and a file storage server 114 coupled to front end server 110. File storage server 114 is adapted and configured to store content transmitted from client device 104 via front end server 110. The database 112 is configured for storing metadata describing content.

The front end server 110 can off-load transactions and/or delivery of content to other servers, if desired. Data network 106 can refer to one or more data networks, typically, high data-bandwidth networks, namely, wired networks, such as the Internet, Ethernet, gigabit Ethernet, and fiber optic, as well as wireless networks such as IEEE 802.11(a), (b) or (g) (WiFi), IEEE 802.16 (WiMax), and Ultra-Wide Band (UWB).

One example of a client game application is the Interactive Buddy 2™ application, produced by Daniel M. Rotar of Youngstown, Ohio. The client devices 104 are, in general, computing devices. As an example, the client devices 104 can be specific or general-purpose personal computers or portable media players. Examples of a client device suitable for use with the invention include the iPad™ and the iPhone™, produced by Apple Inc. The computer program 108 can be used by a user for a variety of purposes, including, but not limited to, browsing, downloading, and/or purchasing content from the on-line central repository 102, creating content, and uploading content.

The front end server 110 enables the user of a particular client device 104 to browse metadata regarding content stored in file storage server 114. Subsequently, the client device 104 can attempt to download the content from the front end server 110 via the data network 106. As will be understood by those familiar with data networks, other network configurations are possible. Furthermore, while the front end server 110, database 112, and file storage server 114 are shown as individual and separate devices, it will be understood by those familiar with the art that other configurations are possible. As one example, each device can be implemented such that it is distributed over multiple server computers. As another example, these various servers and/or managers can be implemented by a single physical server computer.

FIG. 2 is a process flow diagram illustrating an exemplary method 200 of the present invention. The method 200 can, for example, be used with an electronic system, such as the electronic system 100 illustrated in FIG. 1. A first user generates 202 content that includes and/or has been created through the use of purchasable virtual items that have been purchased by the first user. In an exemplary embodiment, the first user generates the content on a mobile device. Alternatively, the first user may generate content through use of an internet browser. The user uploads 204 the content to a central repository. In an exemplary embodiment, the central repository is located on one or more servers. A second user views 206 a list of content, or metadata describing content, that has been stored in the central repository, which includes the first user's content. The second user initiates 208 an action to load the first user's content. The system identifies 210 purchasable items included in or which were used to create content that have not been purchased by the second user. If all items have been purchased, the system allows the second user to load 212 the first user's content. If at least one item included in the content to be loaded has not been purchased by the second user, the system prompts 214 the second user to purchase items in the content to be loaded that the second user has not yet purchased.

FIG. 3 is a process flow diagram illustrating an embodiment of an exemplary client based purchase tracking method according to the present invention. A client game application, which provides a virtual canvas in which a user can construct a scene from or through the use of virtual items, is loaded 302 on a user's mobile device. A user constructs 304 a scene on the virtual canvas using virtual items available to him or her. The user purchases 306 additional virtual items for use in scene construction. The client game application tracks 308 which virtual items have been purchased. The user saves 310 the scene and provides metadata, such as a title, author's name, etc. pertaining to the scene. The client game application automatically generates 312 additional metadata, including a list of virtual items which are included in or were used to create the scene. The user uploads 314 the scene data and metadata to a central repository. The central repository provides 316 a list of metadata to users. A user, using the client game application, receives 318 a list of metadata from the central repository. The user attempts to access 320 a scene identified by its metadata. The client game application determines 322, 324 whether the user has purchased all items present in the list of items included in or which were used to create the scene. If all items have been purchased, the scene data is downloaded 326 and the scene is displayed to the user. If all items have not been purchased, the client game application reveals 328 a menu which lists the items which need to be purchased and allows the user to purchase them.

FIG. 4 is a process flow diagram illustrating an embodiment of an exemplary server based purchase tracking method according to the present invention. A client game application, which provides a virtual canvas in which a user can construct a scene from virtual items, is loaded 402 on a user's mobile device. A user constructs 404 a scene on the virtual canvas using virtual items available to him or her. The user purchases 406 additional virtual items for use in scene construction. The client game application tracks 408 which virtual items have been purchased. The user saves 410 the scene and provides metadata, such as a title, author's name, etc. pertaining to the scene. The user uploads 412 the scene data and metadata to a central repository. The central server generates 414 additional metadata, including a list of virtual items which are included in or which were used to create the scene, which it determines from the scene data. The central repository provides 416 a list of metadata to users. A user, using the client game application, receives 418 a list of metadata from the central repository. The user attempts to access 420 a scene identified by its metadata. The central server determines 422, 424 whether the user has purchased all items present in the list of items included in the scene. If all items have been purchased, the scene data is downloaded 426 and the scene is displayed to the user. If all items have not been purchased, the central server notifies 428 the client game application, which reveals a menu which lists the items which need to be purchased and allows the user to purchase them.

FIG. 5 is a block diagram illustrating an aspect of a client based purchase tracking system 500 according to the present invention. Purchase tracking system 500 includes a repository 502, a first client device 504a, and a second client device 504b. Repository 502 is connected with first client device 504a and second client device 504b. Each client device 504a, 504b hosts a respective client game application (CGA) 506a, 506b. Client game application 506a, 506b provides a virtual canvas 508a, 508b on which a user can construct a scene from virtual items which are provided by the application, thereby enabling a user to produce user generated content. Such virtual items may, for example, include game characters, objects, sounds, and other items. Some of the virtual items may be used to enable a user to create content, such as, for example, a virtual paint brush which enables a user to draw onto a canvas. Some of the virtual items may be immediately available to the user upon downloading or purchasing the application. While other items are purchasable virtual items, which are only made available to the user once the user earned the item. For example, some purchasable items are only made available to the user once the user has reached a predetermined level or rank within the application 506a, 506b. Other purchasable items may only be made available to the user once the user purchases the item through a virtual item purchasing mechanism 510a, 510b provided by the application 506a, 506b.

Repository 502 includes a database 512 and a file storage server 514. File storage server 514 is adapted and configured to store virtual scene content transmitted from client game applications 506a, 506b. The database 512 is configured for storing metadata describing virtual scene content stored in file storage server 514. The database 512 may also be configured for storing metadata describing virtual items which were used to create scene content stored in file storage server 514.

Virtual item purchasing mechanism 510a, 510b is adapted and configured for tracking purchasable virtual items which have been acquired or purchased by the user. Virtual item purchasing mechanism 510a, 510b provides mechanisms enabling user to upload scene data and metadata to repository 502, enabling user to download scene data and metadata from repository 502, determining whether user has purchased all items included in a scene attempted to be downloaded, providing a menu which lists items which have not been purchased, and enabling user to purchase unpurchased items.

FIG. 6 is a block diagram illustrating an aspect of a server based purchase tracking system 600 according to the present invention. Purchase tracking system 600 includes a repository 602, a first client device 604a, and a second client device 604b. Repository 602 is connected with first client device 604a and second client device 604b. Each client device 604a, 604b hosts a respective client game application (CGA) 606a, 606b. Client game application 606a, 606b provides a virtual canvas 608a, 608b on which a user can construct a scene from virtual items which are provided by the application, thereby enabling a user to produce user generated content. Such virtual items may, for example, include game characters, objects, sounds, and other items. Some of the virtual items may be used to enable a user to create content, such as, for example, a virtual paint brush which enables a user to draw onto a canvas. Some of the virtual items may be immediately available to the user upon downloading or purchasing the application. While other items are purchasable virtual items, which are only made available to the user once the user earned the item. For example, some purchasable items are only made available to the user once the user has reached a predetermined level or rank within the application 606a, 606b. Other purchasable items may only be made available to the user once the user purchases the item through a virtual item purchasing mechanism 610a, 610b provided by the application 606a, 606b.

Repository 602 includes a database 612 and a file storage server 614. File storage server 614 is adapted and configured to store virtual scene content transmitted from client game applications 606a, 606b. The database 612 is configured for storing metadata describing virtual scene content stored in file storage server 614 and data for tracking purchasable virtual items which have been acquired or purchased by each user.

Virtual item purchasing mechanism 610a, 610b provides mechanisms enabling user to upload scene data and metadata to repository 502, enabling user to download scene data and metadata from repository 502, determining whether user has purchased all items included in or used in the creation of a scene attempted to be downloaded, providing a menu which lists items which have not been purchased, and enabling user to purchase unpurchased items.

FIG. 7 illustrates an example of a user menu 700 which may be created as part of a client game application according to the present invention. The menu 700 provides a user of the client game application with a list of virtual scene files which have been uploaded to a central repository and metadata pertaining to the files. The menu further provides the user of the client game application with a virtual push button which the user can use to attempt to download a scene saved on a central repository.

FIG. 8 illustrates an example of a user menu 800 which may be created as part of a client game application according to the present invention. The menu 800 provides a user of the client game application with a list of virtual items needed to be purchased before the user can download a selected virtual scene from a central repository, which contains stored scenes previously uploaded by users. In an exemplary embodiment of the menu 800, the menu 800 displays an icon of items which need to be purchased, the name of each of the items, the cost, in currency or game credits, as appropriate, of each of the items, and the amount of currency and game credits currently available to the user. The menu highlights the items in which the cost is lower than the amount of the user's currently available currency and credits, and which, therefore, the user can now purchase. The menu only enables the user to continue to download the virtual scene if the user proceeds to purchase all required items that need to be purchased.

While this invention has been described in terms of the preferred embodiments thereof, it is not intended to be so limited, but rather only to the extent set forth in the claims that follow.

I claim:

1. A method comprising:
storing content created by a first user, the content comprising or having been created through the use of one or more purchasable virtual items;
storing metadata associated with the content;
providing a second user access to the metadata;
identifying purchasable virtual items contained within or having been used to create the content which have not been purchased by the second user;
providing the second user access to the content if the second user has purchased all of the one or more purchasable virtual items contained within or having been used to create the content; and
preventing the second user from accessing the content if the second user has not purchased all of the one or more purchasable virtual items contained within or having been used to create the content.

2. The method of claim 1, further comprising presenting the second user with the option to purchase all of the one or more the purchasable virtual items needed to access the content if the second user has not purchased all of the one or more purchasable virtual items contained within or having been used to create the content.

3. The method of claim 2, wherein the step of presenting the second user with the option of purchasing the purchasable virtual items needed to access the content is performed in response to an attempt to access the content.

4. The method of claim 1, wherein the purchasable virtual items contained within or having been used to create the content are arranged and/or configured by the first user before the content is stored.

5. The method of claim 1, wherein the metadata and content is provided to the user through a mobile device.

6. The method of claim 1, wherein the metadata and content is provided to the user through an internet browser.

7. The method of claim 1, wherein the purchasable virtual items can be purchased using actual currency.

8. The method of claim 1, wherein the purchasable virtual items can be purchased using virtual currency.

9. An electronic system comprising:
at least two applications and a central repository, each one of the at least two applications configured to communicate with the central repository;
a first application of the at least two applications configured to facilitate the generation of content composed of or through the use of one or more purchasable virtual items, to convert the content into transmittable content data, and to transmit the content data to the central repository;
the central repository configured to receive, store, and transmit content data;
the second application of the at least two applications configured to request access to specific content data from the central repository, receive the content data, convert the content data into human viewable content, and display the content; and
at least one of the two applications and the central repository configured to identify which virtual items are contained within or were used to create the content, but which have not been purchased by the user attempting to view the content, and to disallow viewing of the content by the user until the unpurchased items are purchased by the user.

10. The electronic system of claim 9, wherein the first and second applications are identical.

11. The electronic system of claim 9, wherein the first and second applications are distinct from each other.
